(19) United States
(12) Patent Application Publication
(10) Pub. No.: US 2026/0303336 A1
(43) Pub. Date: Oct. 1, 2026

(54) SYSTEMS AND METHODS FOR SECURELY MANAGING ACCESS TO DATA AND SYSTEMS USING ENCRYPTED ATTRIBUTES AND REAL-TIME DISTRIBUTED NETWORK VERIFICATION

(71) Applicant: BANK OF AMERICA CORPORATION, Charlotte, NC (US)

(72) Inventors: Durga Prasad Kutthumolu, Hyderabad (IN); Subburathinam Krishnan, Chennai (IN)

(73) Assignee: BANK OF AMERICA CORPORATION, Charlotte, NC (US)

(21) Appl. No.: 19/091,996

(22) Filed: Mar. 27, 2025

(51) Int. Cl. H04L 9/08; H04L 9/32; H04L 9/40

(52) U.S. Cl. CPC H04L 9/0863; H04L 9/0866; H04L 9/3218; H04L 9/3231; H04L 63/102

(57) ABSTRACT

Systems, computer program products, and methods are described herein for securely managing access to data and systems using encrypted attributes and real-time distributed network verification. Embodiments of the present disclosure are configured to receive a registration request to register a user and create, in response to the registration request, a cryptographic key, a proof protocol, a decentralized identifier, and a credential for the user. Some embodiments are configured to transmit the cryptographic key and the credential to cause an access management application to (i) prompt the user to select five different attributes for verification and (ii) encrypt the selected attributes using the cryptographic key. Some embodiments are configured to use the proof protocol and a distributed ledger to determine whether a threshold number of current attributes corresponding to the five encrypted attributes match the five encrypted attributes in response to an authentication request.

### FIELD OF THE INVENTION

The present invention embraces a system for securely managing access to data and systems using encrypted attributes and real-time distributed network verification.

### BACKGROUND

Identity and access management systems currently use a variety of methods to ensure the security of data and systems. Standards for such identity and access management systems are diverse and frequently modified by governing bodies in multiple jurisdictions.

Applicant has identified a number of deficiencies and problems associated with securely managing access to data and systems. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for securely managing access to data and systems using encrypted attributes and real-time distributed network verification may include a network interface configured to communicate via a communication network, at least one non-transitory storage device including computer program code stored thereon, and at least one processing device operably coupled to the network interface and the at least one non-transitory storage device. In some embodiments, the computer program code may include computer instructions configured to cause the processing device to connect to receive, via the communication network, using the network interface, and from an access management application executing on a user device associated with a user, a registration request to register the user in an access management system associated with the access management application. The computer program code may include computer instructions configured to cause the processing device to create, in response to the registration request, a cryptographic key, a proof protocol, a decentralized identifier, and a credential for the user. The computer program code may include computer instructions configured to cause the processing device to transmit, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes. The computer program code may include computer instructions configured to cause the processing device to receive, via the communication network, using the network interface, and from the access management application executing on the user device, the five encrypted attributes and register the user on a distributed ledger of the access management system using the decentralized identifier and the five encrypted attributes. The computer program code may include computer instructions configured to cause the processing device to receive, via the communication network, using the network interface, and after registering the user, an authentication request including the proof protocol and the credential for the user. The computer program code may include computer instructions configured to cause the processing device to determine, in response to receiving the authentication request, using the proof protocol, and via the distributed ledger of the access management system, whether a threshold number of current attributes corresponding to the five encrypted attributes match the five encrypted attributes. The computer program code may include computer instructions configured to cause the processing device to authenticate, in response to determining that the threshold number of current attributes corresponding to the five encrypted attributes match the five encrypted attributes, the authentication request.

In some embodiments, the at least one non-transitory storage device may include computer-executable program code that, when executed by the at least one processing device, causes the at least one processing device to, when registering the user on the distributed ledger of the access management system, register the user in the access management system by generating, on the distributed ledger, five tenants associated with the decentralized identifier, wherein each tenant of the five tenants corresponds to an encrypted attribute of the five encrypted attributes. Additionally, or alternatively, the at least one non-transitory storage device may include computer-executable program code that, when executed by the at least one processing device, causes the at least one processing device to, when determining whether the threshold number of current attributes corresponding to the five encrypted attributes match the five encrypted attributes, simulate, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant and determine whether a first number of simulated current attributes that match the five encrypted attributes satisfies a first threshold. In some embodiments, the at least one non-transitory storage device may include computer-executable program code that, when executed by the at least one processing device, causes the at least one processing device to, when determining whether the threshold number of current attributes corresponding to the five encrypted attributes match the five encrypted attributes, determine, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant. Additionally, or alternatively, the at least one non-transitory storage device may include computer-executable program code that, when executed by the at least one processing device, causes the at least one processing device to, when determining whether the threshold number of current attributes corresponding to the five encrypted attributes match the five encrypted attributes, determine whether a second number of determined actual current attributes that match the five encrypted attributes satisfies a second threshold and determine that the threshold number of current attributes corresponding to the five encrypted attributes matches the five encrypted attributes if the second number of determined actual current attributes that match the five encrypted attributes satisfies the second threshold.

In some embodiments, the at least one non-transitory storage device may include computer-executable program code that, when executed by the at least one processing device, causes the at least one processing device to, after authenticating the authentication request, receive, using the access management system and from a device associated with the user, an access request to access data and permit, in response to authenticating the authentication request and in response to receiving the access request, the device to access the data.

In some embodiments, the at least one non-transitory storage device may include computer-executable program code that, when executed by the at least one processing device, causes the at least one processing device to, after authenticating the authentication request, receive, using the access management system and from a device associated with the user, a resource distribution request to perform a resource distribution and perform, in response to authenticating the authentication request and in response to receiving the resource distribution request, the resource distribution.

In some embodiments, the at least one non-transitory storage device may include computer-executable program code that, when executed by the at least one processing device, causes the at least one processing device to, in response to creating the cryptographic key, the proof protocol, the decentralized identifier, and the credential for the user, store the proof protocol and the decentralized identifier in the access management system and associate, in the access management system, the proof protocol and the decentralized identifier.

In some embodiments, the at least one non-transitory storage device may include computer-executable program code that, when executed by the at least one processing device, causes the at least one processing device to, when transmitting the cryptographic key and the credential, cause the access management application to prompt the user to select or deselect biometric enrollment and cause the access management application to, in response to the user selecting biometric enrollment, (i) capture biometric data, (ii) encrypt the biometric data using the cryptographic key to create one or more of the five encrypted attributes, and (iii) store the biometric data on the user device.

In some embodiments, the five different attributes may include authorized locations of the user device, an orientation of the user device, a gesture performed by the user while a camera of the user device records the user, entry of a code to the user device, and the user device accessing a website.

In some embodiments, the at least one non-transitory storage device may include computer-executable program code that, when executed by the at least one processing device, causes the at least one processing device to, when transmitting the cryptographic key and the credential, cause the access management application to prompt the user to select the five different attributes for verification and select one or more additional attributes for verification and encrypt the selected one or more additional attributes for verification.

In another aspect, computer program product for securely managing access to data and systems using encrypted attributes and real-time distributed network verification may include a non-transitory computer-readable medium. In some embodiments, the non-transitory computer-readable medium may include code causing an apparatus to receive, via a communication network, using a network interface of the apparatus, and from an access management application executing on a user device associated with a user, a registration request to register the user in an access management system associated with the access management application and create, in response to the registration request, a cryptographic key, a proof protocol, a decentralized identifier, and a credential for the user. The non-transitory computer-readable medium may include code causing an apparatus to transmit, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes. The non-transitory computer-readable medium may include code causing an apparatus to receive, via the communication network, using the network interface, and from the access management application executing on the user device, the five encrypted attributes and register the user on a distributed ledger of the access management system using the decentralized identifier and the five encrypted attributes. The non-transitory computer-readable medium may include code causing an apparatus to receive, via the communication network, using the network interface, and after registering the user, an authentication request including the proof protocol and the credential for the user and determine, in response to receiving the authentication request, using the proof protocol, and via the distributed ledger of the access management system, whether a threshold number of current attributes corresponding to the five encrypted attributes match the five encrypted attributes. The non-transitory computer-readable medium may include code causing an apparatus to authenticate, in response to determining that the threshold number of current attributes corresponding to the five encrypted attributes match the five encrypted attributes, the authentication request.

In some embodiments, the non-transitory computer-readable medium may include code causing an apparatus to, when registering the user on the distributed ledger of the access management system, register the user in the access management system by generating, on the distributed ledger, five tenants associated with the decentralized identifier, where each tenant of the five tenants corresponds to an encrypted attribute of the five encrypted attributes. Additionally, or alternatively, the non-transitory computer-readable medium may include code causing an apparatus to, when determining whether the threshold number of current attributes corresponding to the five encrypted attributes match the five encrypted attributes, simulate, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant. In some embodiments, the non-transitory computer-readable medium may include code causing an apparatus to, when determining whether the threshold number of current attributes corresponding to the five encrypted attributes match the five encrypted attributes, determine whether a first number of simulated current attributes that match the five encrypted attributes satisfies a first threshold and determine, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant. Additionally, or alternatively, the non-transitory computer-readable medium may include code causing an apparatus to, when determining whether the threshold number of current attributes corresponding to the five encrypted attributes match the five encrypted attributes, determine whether a second number of determined actual current attributes that match the five encrypted attributes satisfies a second threshold and determine that the threshold number of current attributes corresponding to the five encrypted attributes matches the five encrypted attributes if the second number of determined actual current attributes that match the five encrypted attributes satisfies the second threshold.

In some embodiments, the non-transitory computer-readable medium may include code causing an apparatus to, after authenticating the authentication request, receive, using the access management system and from a device associated with the user, an access request to access data and permit, in response to authenticating the authentication request and in response to receiving the access request, the device to access the data.

In some embodiments, the non-transitory computer-readable medium may include code causing an apparatus to, after authenticating the authentication request, receive, using the access management system and from a device associated with the user, a resource distribution request to perform a resource distribution and perform, in response to authenticating the authentication request and in response to receiving the resource distribution request, the resource distribution.

In some embodiments, the non-transitory computer-readable medium may include code causing an apparatus to, in response to creating the cryptographic key, the proof protocol, the decentralized identifier, and the credential for the user, store the proof protocol and the decentralized identifier in the access management system and associate, in the access management system, the proof protocol and the decentralized identifier.

In some embodiments, the non-transitory computer-readable medium may include code causing an apparatus to, when transmitting the cryptographic key and the credential, cause the access management application to prompt the user to select or deselect biometric enrollment and cause the access management application to, in response to the user selecting biometric enrollment, (i) capture biometric data, (ii) encrypt the biometric data using the cryptographic key to create one or more of the five encrypted attributes, and (iii) store the biometric data on the user device.

In another aspect, a method for securely managing access to data and systems using encrypted attributes and real-time distributed network verification may include receiving, via a communication network, using a network interface of a system, and from an access management application executing on a user device associated with a user, a registration request to register the user in an access management system associated with the access management application. The method may include creating, in response to the registration request, a cryptographic key, a proof protocol, a decentralized identifier, and a credential for the user. The method may include transmitting, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes. The method may include receiving, via the communication network, using the network interface, and from the access management application executing on the user device, the five encrypted attributes and registering the user on a distributed ledger of the access management system using the decentralized identifier and the five encrypted attributes. The method may include receiving, via the communication network, using the network interface, and after registering the user, an authentication request including the proof protocol and the credential for the user. The method may include determining, in response to receiving the authentication request, using the proof protocol, and via the distributed ledger of the access management system, whether a threshold number of current attributes corresponding to the five encrypted attributes match the five encrypted attributes. The method may include authenticating, in response to determining that the threshold number of current attributes corresponding to the five encrypted attributes match the five encrypted attributes, the authentication request.

In some embodiments, the method may include, when registering the user on the distributed ledger of the access management system, registering the user in the access management system by generating, on the distributed ledger, five tenants associated with the decentralized identifier, wherein each tenant of the five tenants corresponds to an encrypted attribute of the five encrypted attributes. Additionally, or alternatively, the method may include, when determining whether the threshold number of current attributes corresponding to the five encrypted attributes match the five encrypted attributes, simulating, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant. In some embodiments, the method may include, when determining whether the threshold number of current attributes corresponding to the five encrypted attributes match the five encrypted attributes, determining whether a first number of simulated current attributes that match the five encrypted attributes satisfies a first threshold. Additionally, or alternatively, the method may include, when determining whether the threshold number of current attributes corresponding to the five encrypted attributes match the five encrypted attributes, determining, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant. Additionally, or alternatively, the method may include, when determining whether the threshold number of current attributes corresponding to the five encrypted attributes match the five encrypted attributes, determining whether a second number of determined actual current attributes that match the five encrypted attributes satisfies a second threshold and determining that the threshold number of current attributes corresponding to the five encrypted attributes matches the five encrypted attributes if the second number of determined actual current attributes that match the five encrypted attributes satisfies the second threshold.

In some embodiments, the method may include, after authenticating the authentication request, receiving, using the access management system and from a device associated with the user, an access request to access data and permitting, in response to authenticating the authentication request and in response to receiving the access request, the device to access the data.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrate technical components of an exemplary distributed computing environment for securely managing access to data and systems using encrypted attributes and real-time distributed network verification, in accordance with an embodiment of the disclosure;

FIG. 2A illustrates an exemplary distributed ledger technology (DLT) architecture, in accordance with an embodiment of the disclosure;

FIG. 2B illustrates an exemplary transaction object, in accordance with an embodiment of the disclosure;

FIGS. 3A and 3B illustrate exemplary process flows for securely managing access to data and systems using encrypted attributes and real-time distributed network verification, in accordance with an embodiment of the disclosure;

FIG. 4 illustrates a process flow for securely managing access to data and systems using encrypted attributes and real-time distributed network verification, in accordance with an embodiment of the disclosure; and

FIG. 5 illustrates another process flow for securely managing access to data and systems using encrypted attributes and real-time distributed network verification, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, and/or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, and/or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and/or the like.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this invention, a resource is typically stored in a resource repository-a storage location where one or more resources are organized, stored, and retrieved electronically using a computing device.

As used herein, a “resource transfer,” “resource distribution,” or “resource allocation” may refer to any transaction, activities, or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction,” “transaction event,” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present disclosure may include a system, computer program, and/or method for securely managing access to data and systems using encrypted attributes and real-time distributed network verification. Identity and access management systems currently use a variety of methods to ensure the security of data and systems. Standards for such identity and access management systems are diverse and frequently modified by governing bodies in multiple jurisdictions.

Accordingly, the invention may include a system, computer program, and method for securely managing access to data and systems using encrypted attributes and real-time distributed network verification. Embodiments of the present disclosure may include a system configured to receive, via a communication network, using a network interface, and from an access management application executing on a user device associated with a user, a registration request to register the user in an access management system associated with the access management application. The system may be configured to create, in response to the registration request, a cryptographic key, a proof protocol, a decentralized identifier, and a credential for the user. The system may be configured to transmit, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes. The system may be configured to receive, via the communication network, using the network interface, and from the access management application executing on the user device, the five encrypted attributes and register the user on a distributed ledger of the access management system using the decentralized identifier and the five encrypted attributes. The system may be configured to receive, via the communication network, using the network interface, and after registering the user, an authentication request including the proof protocol and the credential for the user. The system may be configured to determine, in response to receiving the authentication request, using the proof protocol, and via the distributed ledger of the access management system, whether a threshold number of current attributes corresponding to the five encrypted attributes match the five encrypted attributes. The system may be configured to authenticate, in response to determining that the threshold number of current attributes corresponding to the five encrypted attributes match the five encrypted attributes, the authentication request.

In some embodiments, the system may be configured to, when registering the user on the distributed ledger of the access management system, register the user in the access management system by generating, on the distributed ledger, five tenants associated with the decentralized identifier, wherein each tenant of the five tenants corresponds to an encrypted attribute of the five encrypted attributes. Additionally, or alternatively, the system may be configured to, when determining whether the threshold number of current attributes corresponding to the five encrypted attributes match the five encrypted attributes, simulate, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant and determine whether a first number of simulated current attributes that match the five encrypted attributes satisfies a first threshold. In some embodiments, the system may be configured to, when determining whether the threshold number of current attributes corresponding to the five encrypted attributes match the five encrypted attributes, determine, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant. Additionally, or alternatively, the system may be configured to, when determining whether the threshold number of current attributes corresponding to the five encrypted attributes match the five encrypted attributes, determine whether a second number of determined actual current attributes that match the five encrypted attributes satisfies a second threshold and determine that the threshold number of current attributes corresponding to the five encrypted attributes matches the five encrypted attributes if the second number of determined actual current attributes that match the five encrypted attributes satisfies the second threshold.

What is more, the present invention provides a technical solution to a technical problem. As described herein, the technical problem includes maintaining identity and access management systems to ensure the security of data and systems given diverse and frequently modified standards, while also maintaining the privacy and security of user data used to provide authentication. The technical solution presented herein allows for a system configured to create encryption tools for a user (e.g., a cryptographic key, a proof protocol, a decentralized identifier, and a credential), provide the encryption tools to the user's device to allow localized encryption of verification attributes used to authenticate the user, register the user in a distributed ledger (e.g., a blockchain) using the encrypted attributes, and then later use the distributed ledger to verify the attributes in real-time to authenticate the user, thereby allowing the user to access data, a system, services from an entity, and/or the like. Furthermore, the distributed ledger may use an optimistic deterministic concurrency control protocol to authenticate the user. On receiving a block of authentication, the distributed ledger may execute authentication in two steps: a simulation step and a commit step, without using static analysis. The simulation step may obtain deterministic read-write sets by simulating authentication against the same block snapshot. After all authentication and authorization of the current block finish simulation, the distributed ledger may enter the commit step to carry out a deterministic commit. In such a way, the distributed ledger may reduce the termination rate of deception using broader dependency information.

The absence of static analysis may allow for greater adaptability and efficiency and not rely on predefined rules or assumptions about authentication behavior. Instead, the system dynamically evaluates authentications based on their interactions within the current block snapshot, providing a more flexible and scalable approach to concurrency control. The emphasis on reducing the termination rate of deception through the use of broader dependency information underscores the system's commitment to security and integrity. By analyzing a wider range of authentication dependencies, the system may detect and prevent deceptive activities more effectively, safeguarding the integrity of the blockchain network.

In particular, a system for securely managing access to data and systems using encrypted attributes and real-time distributed network verification is an improvement over existing solutions, (i) with fewer steps to achieve the solution, thus reducing the amount of computing resources, such as processing resources, storage resources, network resources, and/or the like, that are being used (e.g., by using a distributed ledger to verify an authentication request more attributes may be assessed simultaneously than in a conventional multi-factor authentication assessing each attribute and in fewer steps, thereby consuming fewer processing, storage, and/or network resources), (ii) providing a more accurate solution to the problem, thus reducing the number of resources required to remedy any errors made due to a less accurate solution (e.g., verifying more attributes than in a conventional multi-factor authentication reduces the likelihood of false authentications, faked authentications, deceptive authentications, and/or the like such that fewer corrective actions are required), (iii) removing manual input and waste from the implementation of the solution, thus improving speed and efficiency of the process and conserving computing resources (e.g., by using a distributed ledger to verify authentication requests human interaction with the authentication management system may be substantially or completely removed), and (iv) determining an optimal amount of resources that need to be used to implement the solution, thus reducing network traffic and load on existing computing resources (e.g., by using a distributed ledger to very multiple attributes until enough attributes have been verified that the system is confident that the authentication request is valid, an optimal amount of resources for performing the verification may be used as compared to resources spent on conventional verification processes). Additionally, as mentioned, the distributed ledger may perform authentications using a simulation step and a commit step, without using static analysis. By using a simulation step before performing the commit step, the system reduces the amount of resources consumed by deceptive authentication requestions. By foregoing the use of static analysis, the system may provide more security than a conventional process. Furthermore, the technical solution described herein uses a rigorous, computerized process to perform specific tasks and/or activities that were not previously performed. In specific implementations, the technical solution bypasses a series of steps previously implemented, thus further conserving computing resources.

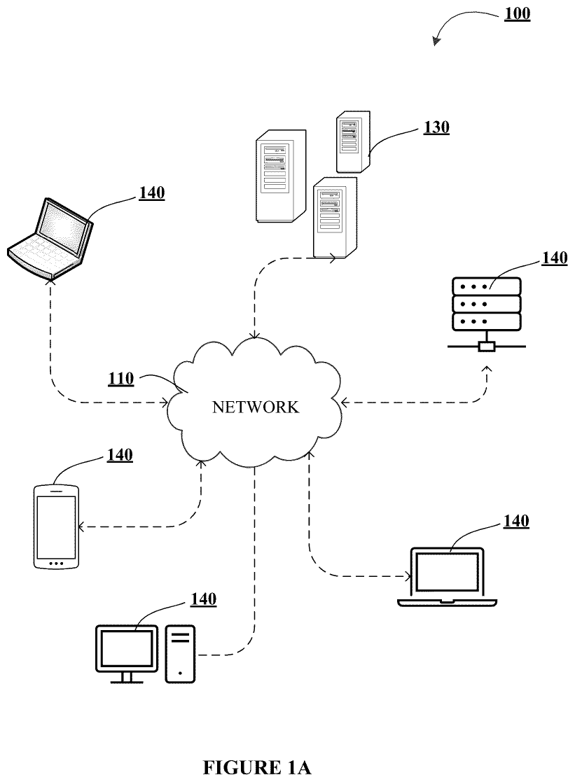

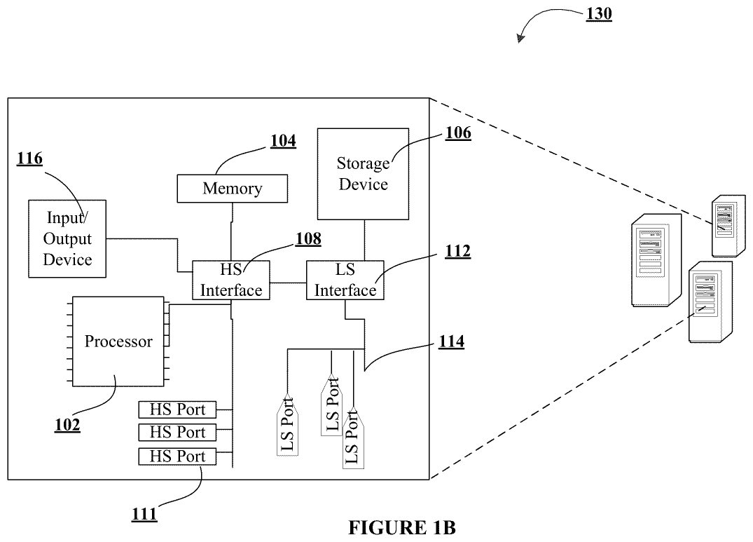

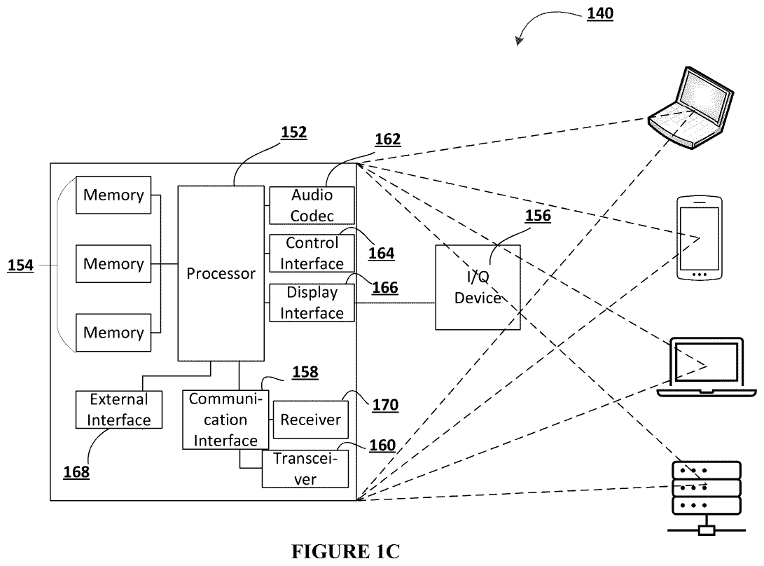

FIGS. 1A-1C illustrate technical components of an exemplary distributed computing environment 100 for securely managing access to data and systems using encrypted attributes and real-time distributed network verification, in accordance with an embodiment of the invention. As shown in FIG. 1A, the distributed computing environment 100 contemplated herein may include a system 130 (i.e., a system for securely managing access to data and systems using encrypted attributes and real-time distributed network verification), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

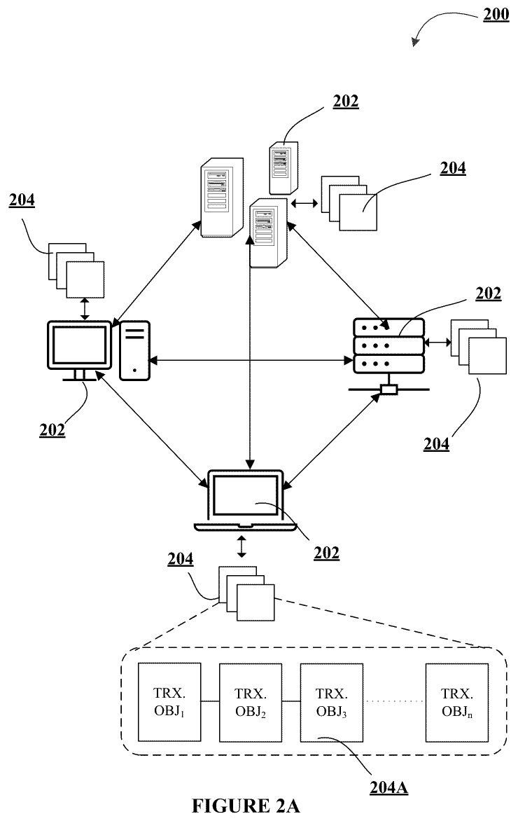

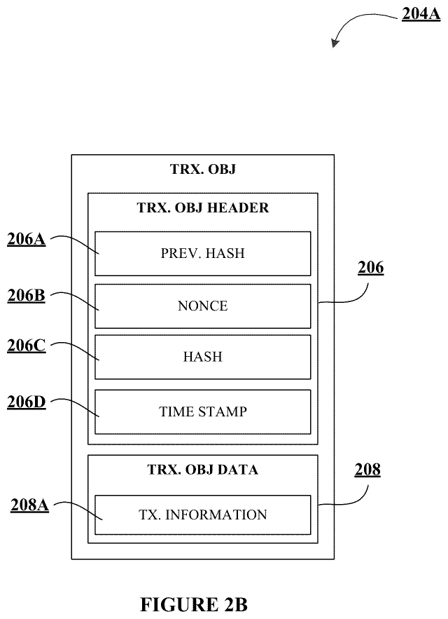

FIGS. 2A-2B illustrate an exemplary distributed ledger technology (DLT) architecture, in accordance with an embodiment of the invention. DLT may refer to the protocols and/or supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the transaction objects before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically execute all of or parts of an agreement and are stored on a DLT platform. The code can either be the sole manifestation of the agreement between the parties or might complement a traditional text-based contract and execute certain provisions, such as transferring funds from Party A to Party B. The code itself may be replicated across multiple nodes (peers) and, therefore, may benefit from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowdfunding, synchronous/asynchronous communication, decentralized real-time ride sharing and even a general-purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world may send transactions to and expect to see them included if they are valid, and anyone in the world can participate in the consensus process for determining which transaction objects are added to the distributed ledger and what the current state of each transaction object is. A public distributed ledger is generally considered to be fully decentralized. On the other hand, a fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 may include a distributed ledger 204 being maintained on multiple devices (nodes) 202 that are authorized to keep track of the distributed ledger 204. For example, the nodes 202 may be computing devices such as the system 130 and the client device(s) 140. One node of the nodes 202 in the DLT architecture 200 may have a complete or partial copy of the entire distributed ledger 204 or may have a set of transactions and/or transaction objects 204A on the distributed ledger 204. Transactions may be initiated at a node and communicated to the nodes 202 in the DLT architecture 200. Any of the nodes 202 may validate a transaction, record the transaction to its copy of the distributed ledger, and/or broadcast the transaction, its validation (in the form of a transaction object), and/or other data to other nodes.

As shown in FIG. 2B, an exemplary transaction object 204A may include a transaction object header 206 and transaction object data 208. The transaction object header 206 may include a cryptographic hash of a previous transaction object 206A, a nonce 206B (e.g., a randomly generated 32-bit whole number when the transaction object 204A is created), a cryptographic hash of the current transaction object 206C wedded to the nonce 206B, and/or a time stamp 206D. The transaction object data 208 may include transaction information 208A being recorded. Once the transaction object 204A is generated, the transaction information 208A is considered signed and forever tied to the nonce 206B and the cryptographic hash 206C. Once generated, the transaction object 204A is then deployed on the distributed ledger 204. At this time, a distributed ledger address may be generated for the transaction object 204A (e.g., an indication of where the transaction object 204A is located on the distributed ledger 204) and may be captured for recording purposes. Once deployed, the transaction information 208A is considered recorded in the distributed ledger 204.

As noted, the present invention may include a system, computer program, and method for securely managing access to data and systems using encrypted attributes and real-time distributed network verification. In some embodiments, the present invention may embrace a novel deterministic concurrency control protocol referred to as Harmony Encrypted Identity and Access Management (EIAM) for ensuring security and reliability in private blockchains. The present invention may include using Harmony EIAM to achieve unparalleled security through local matching of encrypted identity and access management data within a Harmony Framework. As used herein, Harmony EIAM refers to an optimistic deterministic concurrency control (ODCC) protocol. On receiving a block of authentication, the protocol may execute authentication in two steps: a simulation step and a commit step, without using static analysis. The simulation step may obtain deterministic read-write sets by simulating authentication against the same block snapshot. After all authentication and authorization of the current block finishes simulation, the protocol enters the commit step to carry out a deterministic commit. To reduce the termination rate of deception, private blockchains have been using broader dependency information.

As will be appreciated by one of ordinary skill in the art in view of the present disclosure, the absence of static analysis in Harmony EIAM allows for greater adaptability and efficiency, because it does not rely on predefined rules or assumptions about authentication behavior. Instead, it dynamically evaluates authentications based on their interactions within the current block snapshot, providing a more flexible and scalable approach to concurrency control.

Reducing the termination rate of deception by using broader dependency information enhances the security and integrity of the protocol. By analyzing a wider range of authentication dependencies, Harmony EIAM can detect and prevent deceptive activities more effectively, safeguarding the integrity of the blockchain network. Harmony EIAM implements an ODCC protocol offering a robust framework for authentication execution and concurrency control in private blockchains. Harmony EIAM focuses on efficiency, adaptability, and security making it a useful technique in the evolving landscape of blockchain technology. In this way, the present invention may enable orchestration adaptive unparalleled security through local matching of encrypted identity data in a Harmony framework.

In some embodiments, the present invention may use an EIAM match of at least three to five parties' authentications to verify authorization, including an avatar-to-avatar authentication, a human authentication, an authorized device authentication, an Internet-Of-Things (IOT)-enabled bot authentication, and/or the like. Additionally, or alternatively, Harmony EIAM allows for greater adaptability and efficiency, because it does not rely on predefined rules or assumptions about authentication behavior. Instead, Harmony EIAM dynamically evaluates authentications based on their interactions within the current block snapshot, providing a more flexible and scalable approach to concurrency control.

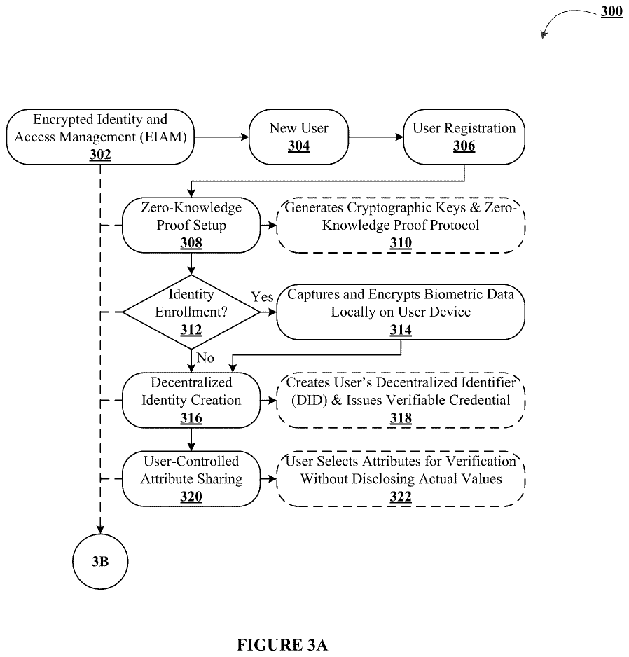

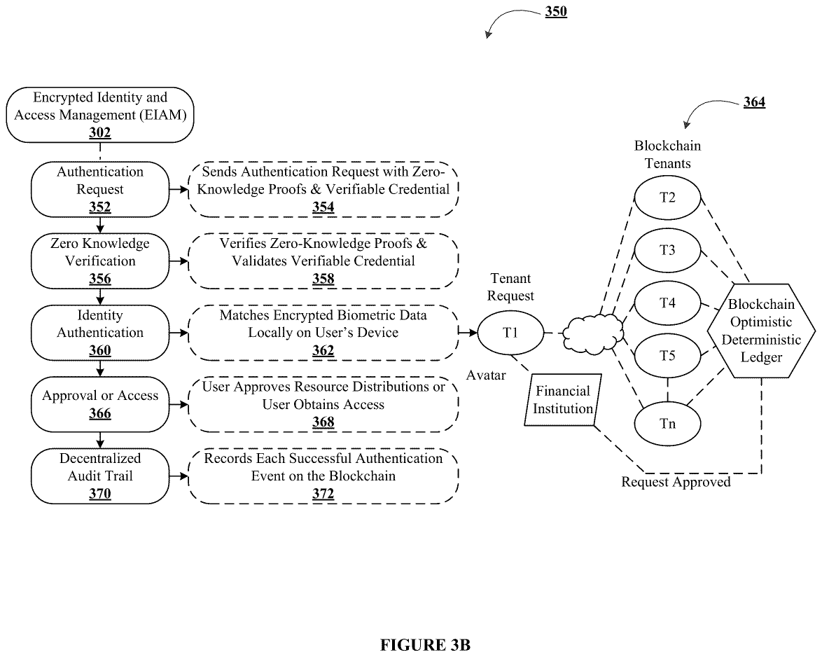

FIGS. 3A and 3B illustrate exemplary process flows 300 and 350, respectively, for securely managing access to data and systems using encrypted attributes and real-time distributed network verification, in accordance with an embodiment of the disclosure. In some embodiments, a system (e.g., similar to one or more of the systems shown and described herein with respect to FIGS. 1A-1C) may perform one or more of the steps of process flows 300 and 350. For example, a system for securely managing access to data and systems using encrypted attributes and real-time distributed network verification (e.g., similar to the system 130 shown and described herein with respect to FIG. 1A-1C) may perform one or more of the steps of process flows 300 and 350. In some embodiments, the system may include and/or use a DLT architecture (e.g., similar to the DLT architecture 200 as shown and described herein with respect to FIGS. 2A and 2B) to perform one or more of the steps of process flows 300 and 350.

As shown in FIG. 3A, the process flow 300 may include the Encrypted Identity and Access Management (EIAM) 302 receiving a registration request to register a new user 304 and initiating user registration 306. The EIAM 302 may include a zero-knowledge proof setup module 308 to generate one or more cryptographic keys and a zero-knowledge proof protocol 310.

As also shown in FIG. 3A, the process flow 300 may include, during the user registration 306, prompting the new user 304 to select whether or not to perform identity enrollment. For example, the EIAM 302 may include an identity enrollment module 312. If the use selects to perform identity enrollment, the process flow 300 may include capturing and encrypting biometric data locally on a user device 314 associated with the user. For example, the process flow 300 may include using the one or more cryptographic keys and/or the zero-knowledge proof protocol to encrypt the biometric data (e.g., data including biometric information and/or the like). By encrypting the biometric data locally on the user device, the process flow 300 may enable the user to maintain control and privacy of the biometric data such that the biometric data cannot be duplicated or misappropriated by a bad actor.

As shown in FIG. 3A, the process flow 300 may include using a decentralized identity creation module 316 of the EIAM 302 to create the user's decentralized identifier (DID) and issue a verifiable credential 318 to the user. For example, the process flow 300 may include creating the user's DID, storing the user's DID and the zero-knowledge proof protocol in the access management system, and associating the user's DID and the zero-knowledge proof protocol with each other in the access management system.

As shown in FIG. 3A, the process flow 300 may include using a user-controlled attribute sharing module 320 of the EIAM 302 to permit the user to select attributes for verification without disclosing actual values 322. For example, the process flow 300 may include causing an application executing on a user device of the user to display different types of attributes for verification and to receive the user's selection of the attributes. In some embodiments, the application is configured to (i) store the actual values of the selected attributes locally on the user device, (ii) encrypt the actual values and/or the selected attributes using the cryptographic key, and (iii) transmit the encrypted actual values and/or the selected attributes to the EIAM 302. Additionally, or alternatively, the process flow 300 may include registering the user in the EIAM 302 and/or the access management system using the user's DID and the encrypted actual values and/or the selected attributes. In this regard, the process flow 300 may be referred to as a user registration process, in some embodiments.

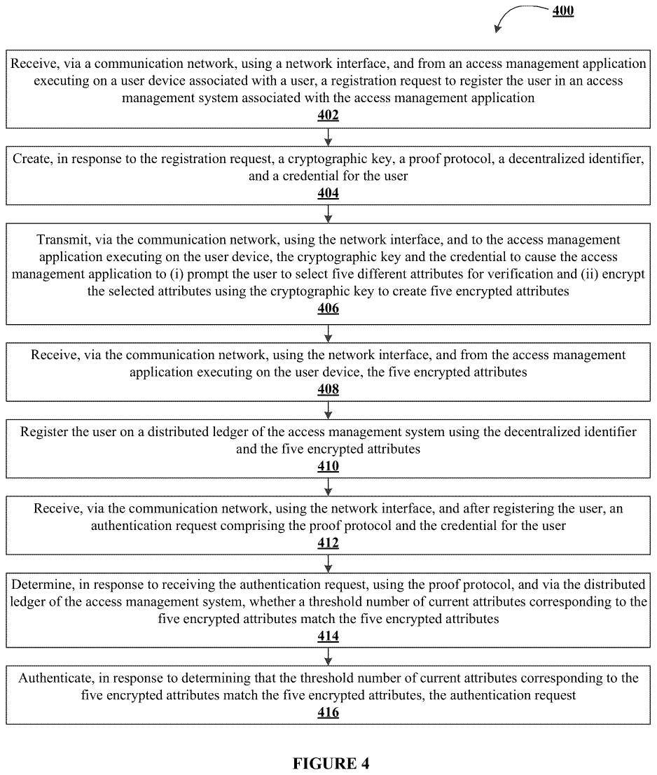

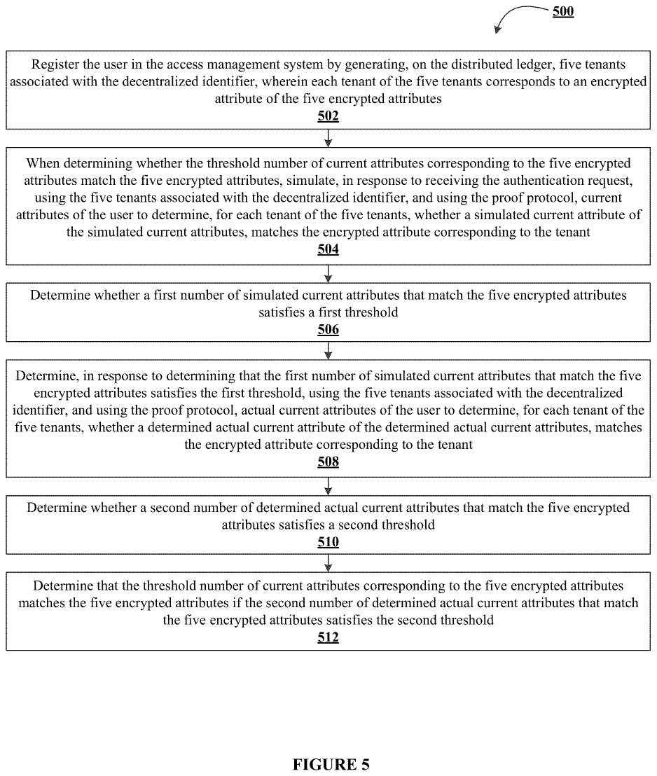

The process flow 300 may include additional embodiments, such as any single embodiment or any combination of embodiments described herein. Although FIG. 3A shows example blocks of the process flow 300, in some embodiments, the process flow 300 may include additional blocks, fewer blocks, different blocks, or differently arranged blocks than those depicted in FIG. 3A. For example, the process flow 300 may include one or more of the steps and/or blocks as shown and described herein with respect to the process flow 350 of FIG. 3B, the process flow 400 of FIG. 4, and/or the process flow 500 of FIG. 5. Additionally, or alternatively, two or more of the blocks of the process flow 300 may be performed in parallel.

As shown in FIG. 3B, the process flow 350 may include receiving, with the EIAM 302, an authentication request 352. For example, and as shown in FIG. 3B, a user device, system, and/or the like may send an authentication request with zero-knowledge proofs and a verifiable credential 354 to the EIAM 302.

As shown in FIG. 3B, the process flow 350 may include using a zero-knowledge verification module 356 of the EIAM 302 to verify the zero-knowledge proofs and validate the verifiable credential 358. For example, the process flow 350 may include using the verifiable credential to identify a DID associated with the verifiable credential and determine whether the DID associated with the verifiable credential is registered in the EIAM 302 and/or the access management system.

As shown in FIG. 3B, the process flow 350 may include using an identity authentication module 360 of the EIAM 302 to match encrypted biometric data locally on the user's device 362. For example, and as shown in FIG. 3B, a tenant T1 may generate a tenant request to authenticate a user and provide the authentication request to a cloud-based blockchain optimistic deterministic ledger (e.g., a private blockchain) that includes a plurality of blockchain tenants T2, T3, T4, T5, . . . Tn. Each of the blockchain tenants may receive the request and use the ODCC protocol to execute authentication in two steps, a simulation step and a commit step, to verify one or more of the verification attributes selected by the user during registration, which may include one or more attributes related to biometric data. As shown in FIG. 3B, a selected attribute may include an avatar associated with the user entering and/or interacting with a financial institution in a virtual world (e.g., a Metaverse). If a threshold number of the selected attributes are verified by the blockchain optimistic deterministic ledger (e.g., three of five selected attributes are verified), the request may be approved.

As shown in FIG. 3B, the process flow 350 may include using an approval or access module 366 of the EIAM 302 to permit the user to approve resource distributions or to permit the user to obtain access 368 (e.g., to one or more databases, one or more systems, one or more devices, one or more networks, and/or the like). As also shown in FIG. 3B, the process flow 350 may include using a decentralized audit trail module 370 of the EIAM 302 to record each successful authentication event on the blockchain 372, such that the record may be reviewed if deception, misappropriation, and/or the like are later discovered.

The process flow 350 may include additional embodiments, such as any single embodiment or any combination of embodiments described herein. Although FIG. 3B shows example blocks of the process flow 350, in some embodiments, the process flow 350 may include additional blocks, fewer blocks, different blocks, or differently arranged blocks than those depicted in FIG. 3B. For example, the process flow 350 may include one or more of the steps and/or blocks as shown and described herein with respect to the process flow 300 of FIG. 3A, the process flow 400 of FIG. 4, and/or the process flow 500 of FIG. 5. Additionally, or alternatively, two or more of the blocks of the process flow 350 may be performed in parallel.

FIG. 4 illustrates a process flow 400 for securely managing access to data and systems using encrypted attributes and real-time distributed network verification, in accordance with an embodiment of the disclosure. In some embodiments, a system (e.g., similar to one or more of the systems shown and described herein with respect to FIGS. 1A-1C) may perform one or more of the steps of process flow 400. For example, a system for securely managing access to data and systems using encrypted attributes and real-time distributed network verification (e.g., similar to the system 130 shown and described herein with respect to FIG. 1A-1C) may perform one or more of the steps of process flow 400. In some embodiments, the system may include and/or use a DLT architecture (e.g., similar to the DLT architecture 200 as shown and described herein with respect to FIGS. 2A and 2B) to perform one or more of the steps of process flow 400.

As shown in block 402, the process flow 400 may include the step of receiving, via a communication network, using a network interface, and from an access management application executing on a user device associated with a user, a registration request to register the user in an access management system associated with the access management application. For example, a user may download and/or install an access management application on the user device that is configured to allow the user to interact with the access management system, and the user may use the application to generate and submit the registration request to the access management system.

As shown in block 404, the process flow 400 may include the step of creating, in response to the registration request, a cryptographic key, a proof protocol, a decentralized identifier, and a credential for the user. For example, the process flow 400 may include performing one or more of the steps of the process flow 300 as shown and described herein with respect to FIGS. 3A and 3B to create a cryptographic key, a proof protocol, a decentralized identifier, and a credential for the user.

As shown in block 406, the process flow 400 may include the step of transmitting, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes. For example, the process flow 400 may include performing one or more of the steps of the process flow 300 as shown and described herein with respect to FIGS. 3A and 3B to perform the step of block 406. Additionally, or alternatively, the access management application may be configured to provide a variety of different attributes that may be used to verify authentication requests submitted by the user to grant the user access to one or more databases, one or more systems, one or more devices, and/or the like after the user has been registered.

As shown in block 408, the process flow 400 may include the step of receiving, via the communication network, using the network interface, and from the access management application executing on the user device, the five encrypted attributes. For example, the access management application executing on the user device may be configured to, after receiving the user's selection of the attributes and encrypting the selected attributes, transmit the encrypted attributes to the system.

As shown in block 410, the process flow 400 may include the step of registering the user on a distributed ledger of the access management system using the decentralized identifier and the five encrypted attributes. For example, the process flow 400 may include performing one or more of the steps of the process flow 300 as shown and described herein with respect to FIGS. 3A and 3B to perform the step of block 410. Additionally, or alternatively, the process flow 400 may include performing one or more of the steps of the process flow 500 as shown and described herein with respect to FIG. 5 to perform the step of block 410.

As shown in block 412, the process flow 400 may include the step of receiving, via the communication network, using the network interface, and after registering the user, an authentication request including the proof protocol and the credential for the user. For example, the process flow 400 may include performing one or more of the steps of the process flow 300 as shown and described herein with respect to FIGS. 3A and 3B to perform the step of block 412. Additionally, or alternatively, the process flow 400 may include receiving an authentication request from another entity system and/or user device attempting to determine whether the user is permitted to access one or more databases, one or more systems, one or more devices, and/or the like.

As shown in block 414, the process flow 400 may include the step of determining, in response to receiving the authentication request, using the proof protocol, and via the distributed ledger of the access management system, whether a threshold number of current attributes corresponding to the five encrypted attributes match the five encrypted attributes. For example, the process flow 400 may include performing one or more of the steps of the process flow 300 as shown and described herein with respect to FIGS. 3A and 3B to perform the step of block 414. Additionally, or alternatively, the process flow 400 may include performing one or more of the steps of the process flow 500 as shown and described herein with respect to FIG. 5 to perform the step of block 414.

As shown in block 416, the process flow 400 may include the step of authenticating, in response to determining that the threshold number of current attributes corresponding to the five encrypted attributes match the five encrypted attributes, the authentication request. For example, the process flow 400 may include performing one or more of the steps of the process flow 300 as shown and described herein with respect to FIGS. 3A and 3B to perform the step of block 416. Additionally, or alternatively, the process flow 400 may include performing one or more of the steps of the process flow 500 as shown and described herein with respect to FIG. 5 to perform the step of block 416.

In some embodiments, the process flow 400 may include after authenticating the authentication request, receiving, using the access management system and from a device associated with the user, an access request to access data and permitting, in response to authenticating the authentication request and in response to receiving the access request, the device to access the data. Additionally, or alternatively, the process flow 400 may include, after authenticating the authentication request, receiving, using the access management system and from a device associated with the user, a resource distribution request to perform a resource distribution and performing, in response to authenticating the authentication request and in response to receiving the resource distribution request, the resource distribution.

In some embodiments, the process flow 400 may include, in response to creating the cryptographic key, the proof protocol, the decentralized identifier, and the credential for the user, storing the proof protocol and the decentralized identifier in the access management system and associating, in the access management system, the proof protocol and the decentralized identifier. Additionally, or alternatively, the process flow 400 may include when transmitting the cryptographic key and the credential, causing the access management application to prompt the user to select or deselect biometric enrollment and causing the access management application to, in response to the user selecting biometric enrollment, (i) capture biometric data, (ii) encrypt the biometric data using the cryptographic key to create one or more of the five encrypted attributes, and (iii) store the biometric data on the user device.

In some embodiments, the five different attributes may include authorized locations of the user device, an orientation of the user device, a gesture performed by the user while a camera of the user device records the user, entry of a code to the user device, and the user device accessing a website. Additionally, or alternatively, the process flow 400 may include, when transmitting the cryptographic key and the credential, causing the access management application to prompt the user to select the five different attributes for verification and selecting one or more additional attributes for verification and encrypting the selected one or more additional attributes for verification.

The process flow 400 may include additional embodiments, such as any single embodiment or any combination of embodiments described herein. Although FIG. 4 shows example blocks of the process flow 400, in some embodiments, the process flow 400 may include additional blocks, fewer blocks, different blocks, or differently arranged blocks than those depicted in FIG. 4. For example, the process flow 400 may include one or more of the steps and/or blocks as shown and described herein with respect to the process flow 300 of FIG. 3A, the process flow 350 of FIG. 3B, and/or the process flow 500 of FIG. 5. Additionally, or alternatively, two or more of the blocks of the process flow 400 may be performed in parallel.

FIG. 5 illustrates another process flow 500 for securely managing access to data and systems using encrypted attributes and real-time distributed network verification, in accordance with an embodiment of the disclosure. In some embodiments, a system (e.g., similar to one or more of the systems shown and described herein with respect to FIGS. 1A-1C) may perform one or more of the steps of process flow 500. For example, a system for securely managing access to data and systems using encrypted attributes and real-time distributed network verification (e.g., similar to the system 130 shown and described herein with respect to FIG. 1A-1C) may perform one or more of the steps of process flow 450. In some embodiments, the system may include and/or use a DLT architecture (e.g., similar to the DLT architecture 200 as shown and described herein with respect to FIGS. 2A and 2B) to perform one or more of the steps of process flow 500.

In some embodiments, the process flow 500 may be performed to register a user in an access management system that includes a distributed ledger and/or to determine whether a threshold number of current attributes corresponding to the encrypted attributes match the encrypted attributes (e.g., to determine whether to authenticate an authentication request and/or the like). As shown in block 502, the process flow 500 may include the step of registering the user in the access management system by generating, on the distributed ledger, five tenants associated with the decentralized identifier, wherein each tenant of the five tenants corresponds to an encrypted attribute of the five encrypted attributes. For example, the process flow 500 may include performing one or more of the steps of the process flow 300 as shown and described herein with respect to FIGS. 3A and 3B to perform the step of block 502. Additionally, or alternatively, the process flow 500 may include performing one or more of the steps of the process flow 500 as shown and described herein with respect to FIG. 5 to perform the step of block 502.

As shown in block 504, the process flow 500 may include the step of, when determining whether the threshold number of current attributes corresponding to the five encrypted attributes match the five encrypted attributes, simulating, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant. For example, the process flow 500 may include performing one or more of the steps of the process flow 300 as shown and described herein with respect to FIGS. 3A and 3B to perform the step of block 504. Additionally, or alternatively, the process flow 500 may include performing one or more of the steps of the process flow 500 as shown and described herein with respect to FIG. 5 to perform the step of block 504.

As shown in block 506, the process flow 500 may include the step of determining whether a first number of simulated current attributes that match the five encrypted attributes satisfies a first threshold. For example, the process flow 500 may include performing one or more of the steps of the process flow 300 as shown and described herein with respect to FIGS. 3A and 3B to perform the step of block 506. Additionally, or alternatively, the process flow 500 may include performing one or more of the steps of the process flow 500 as shown and described herein with respect to FIG. 5 to perform the step of block 506.

As shown in block 508, the process flow 500 may include the step of, when determining whether the threshold number of current attributes corresponding to the five encrypted attributes match the five encrypted attributes, determining, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant. For example, the process flow 500 may include performing one or more of the steps of the process flow 300 as shown and described herein with respect to FIGS. 3A and 3B to perform the step of block 508. Additionally, or alternatively, the process flow 500 may include performing one or more of the steps of the process flow 500 as shown and described herein with respect to FIG. 5 to perform the step of block 508.

As shown in block 510, the process flow 500 may include the step of determining whether a second number of determined actual current attributes that match the five encrypted attributes satisfies a second threshold. For example, the process flow 500 may include performing one or more of the steps of the process flow 300 as shown and described herein with respect to FIGS. 3A and 3B to perform the step of block 510. Additionally, or alternatively, the process flow 500 may include performing one or more of the steps of the process flow 500 as shown and described herein with respect to FIG. 5 to perform the step of block 510.

As shown in block 512, the process flow 500 may include the step of determining that the threshold number of current attributes corresponding to the five encrypted attributes matches the five encrypted attributes if the second number of determined actual current attributes that match the five encrypted attributes satisfies the second threshold. For example, the process flow 500 may include performing one or more of the steps of the process flow 300 as shown and described herein with respect to FIGS. 3A and 3B to perform the step of block 512. Additionally, or alternatively, the process flow 500 may include performing one or more of the steps of the process flow 500 as shown and described herein with respect to FIG. 5 to perform the step of block 512.

The process flow 500 may include additional embodiments, such as any single embodiment or any combination of embodiments described herein. Although FIG. 5 shows example blocks of the process flow 500, in some embodiments, the process flow 500 may include additional blocks, fewer blocks, different blocks, or differently arranged blocks than those depicted in FIG. 5. For example, the process flow 500 may include one or more of the steps and/or blocks as shown and described herein with respect to the process flow 300 of FIG. 3A, the process flow 350 of FIG. 3B, and/or the process flow 400 of FIG. 4. Additionally, or alternatively, two or more of the blocks of the process flow 500 may be performed in parallel.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in party to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for securely managing access to data and systems using encrypted attributes and real-time distributed network verification, the system comprising:
a network interface configured to communicate via a communication network;
at least one non-transitory storage device comprising computer program code stored thereon; and
at least one processing device operably coupled to the network interface and the at least one non-transitory storage device, wherein the computer program code comprises computer instructions configured to cause the processing device to:
receive, via the communication network, using the network interface, and from an access management application executing on a user device associated with a user, a registration request to register the user in an access management system associated with the access management application;
create, in response to the registration request, a cryptographic key, a proof protocol, a decentralized identifier, and a credential for the user;
transmit, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes;
receive, via the communication network, using the network interface, and from the access management application executing on the user device, the five encrypted attributes;
register the user on a distributed ledger of the access management system using the decentralized identifier and the five encrypted attributes;
receive, via the communication network, using the network interface, and after registering the user, an authentication request comprising the proof protocol and the credential for the user;
determine, in response to receiving the authentication request, using the proof protocol, and via the distributed ledger of the access management system, whether a threshold number of current attributes corresponding to the five encrypted attributes match the five encrypted attributes; and
authenticate, in response to determining that the threshold number of current attributes corresponding to the five encrypted attributes match the five encrypted attributes, the authentication request.

2. The system of claim 1, wherein the at least one non-transitory storage device comprises computer-executable program code that, when executed by the at least one processing device, causes the at least one processing device to, when registering the user on the distributed ledger of the access management system:
register the user in the access management system by generating, on the distributed ledger, five tenants associated with the decentralized identifier, wherein each tenant of the five tenants corresponds to an encrypted attribute of the five encrypted attributes.

3. The system of claim 2, wherein the at least one non-transitory storage device comprises computer-executable program code that, when executed by the at least one processing device, causes the at least one processing device to, when determining whether the threshold number of current attributes corresponding to the five encrypted attributes match the five encrypted attributes:
simulate, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant;
determine whether a first number of simulated current attributes that match the five encrypted attributes satisfies a first threshold;
determine, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant;
determine whether a second number of determined actual current attributes that match the five encrypted attributes satisfies a second threshold; and
determine that the threshold number of current attributes corresponding to the five encrypted attributes matches the five encrypted attributes if the second number of determined actual current attributes that match the five encrypted attributes satisfies the second threshold.

4. The system of claim 1, wherein the at least one non-transitory storage device comprises computer-executable program code that, when executed by the at least one processing device, causes the at least one processing device to, after authenticating the authentication request:
receive, using the access management system and from a device associated with the user, an access request to access data; and
permit, in response to authenticating the authentication request and in response to receiving the access request, the device to access the data.

5. The system of claim 1, wherein the at least one non-transitory storage device comprises computer-executable program code that, when executed by the at least one processing device, causes the at least one processing device to, after authenticating the authentication request:
receive, using the access management system and from a device associated with the user, a resource distribution request to perform a resource distribution; and
perform, in response to authenticating the authentication request and in response to receiving the resource distribution request, the resource distribution.

6. The system of claim 1, wherein the at least one non-transitory storage device comprises computer-executable program code that, when executed by the at least one processing device, causes the at least one processing device to, in response to creating the cryptographic key, the proof protocol, the decentralized identifier, and the credential for the user:
store the proof protocol and the decentralized identifier in the access management system; and
associate, in the access management system, the proof protocol and the decentralized identifier.

7. The system of claim 1, wherein the at least one non-transitory storage device comprises computer-executable program code that, when executed by the at least one processing device, causes the at least one processing device to, when transmitting the cryptographic key and the credential:
cause the access management application to prompt the user to select or deselect biometric enrollment; and
cause the access management application to, in response to the user selecting biometric enrollment, (i) capture biometric data, (ii) encrypt the biometric data using the cryptographic key to create one or more of the five encrypted attributes, and (iii) store the biometric data on the user device.

8. The system of claim 1, wherein the five different attributes comprise authorized locations of the user device, an orientation of the user device, a gesture performed by the user while a camera of the user device records the user, entry of a code to the user device, and the user device accessing a website.

9. The system of claim 1, wherein the at least one non-transitory storage device comprises computer-executable program code that, when executed by the at least one processing device, causes the at least one processing device to, when transmitting the cryptographic key and the credential:
cause the access management application to prompt the user to select the five different attributes for verification and select one or more additional attributes for verification and encrypt the selected one or more additional attributes for verification.

10. A computer program product for securely managing access to data and systems using encrypted attributes and real-time distributed network verification, the computer program product comprising a non-transitory computer-readable medium comprising code causing an apparatus to:
receive, via a communication network, using a network interface of the apparatus, and from an access management application executing on a user device associated with a user, a registration request to register the user in an access management system associated with the access management application;
create, in response to the registration request, a cryptographic key, a proof protocol, a decentralized identifier, and a credential for the user;
transmit, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes;
receive, via the communication network, using the network interface, and from the access management application executing on the user device, the five encrypted attributes;
register the user on a distributed ledger of the access management system using the decentralized identifier and the five encrypted attributes;
receive, via the communication network, using the network interface, and after registering the user, an authentication request comprising the proof protocol and the credential for the user;
determine, in response to receiving the authentication request, using the proof protocol, and via the distributed ledger of the access management system, whether a threshold number of current attributes corresponding to the five encrypted attributes match the five encrypted attributes; and
authenticate, in response to determining that the threshold number of current attributes corresponding to the five encrypted attributes match the five encrypted attributes, the authentication request.

11. The computer program product of claim 10, wherein the non-transitory computer-readable medium comprises code causing an apparatus to, when registering the user on the distributed ledger of the access management system:
register the user in the access management system by generating, on the distributed ledger, five tenants associated with the decentralized identifier, wherein each tenant of the five tenants corresponds to an encrypted attribute of the five encrypted attributes.

12. The computer program product of claim 11, wherein the non-transitory computer-readable medium comprises code causing an apparatus to, when determining whether the threshold number of current attributes corresponding to the five encrypted attributes match the five encrypted attributes:
simulate, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant;
determine whether a first number of simulated current attributes that match the five encrypted attributes satisfies a first threshold;
determine, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant;
determine whether a second number of determined actual current attributes that match the five encrypted attributes satisfies a second threshold; and
determine that the threshold number of current attributes corresponding to the five encrypted attributes matches the five encrypted attributes if the second number of determined actual current attributes that match the five encrypted attributes satisfies the second threshold.

13. The computer program product of claim 10, wherein the non-transitory computer-readable medium comprises code causing an apparatus to, after authenticating the authentication request:
receive, using the access management system and from a device associated with the user, an access request to access data; and
permit, in response to authenticating the authentication request and in response to receiving the access request, the device to access the data.

14. The computer program product of claim 10, wherein the non-transitory computer-readable medium comprises code causing an apparatus to, after authenticating the authentication request:
receive, using the access management system and from a device associated with the user, a resource distribution request to perform a resource distribution; and
perform, in response to authenticating the authentication request and in response to receiving the resource distribution request, the resource distribution.

15. The computer program product of claim 10, wherein the non-transitory computer-readable medium comprises code causing an apparatus to, in response to creating the cryptographic key, the proof protocol, the decentralized identifier, and the credential for the user:
store the proof protocol and the decentralized identifier in the access management system; and
associate, in the access management system, the proof protocol and the decentralized identifier.

16. The computer program product of claim 10, wherein the non-transitory computer-readable medium comprises code causing an apparatus to, when transmitting the cryptographic key and the credential:
cause the access management application to prompt the user to select or deselect biometric enrollment; and
cause the access management application to, in response to the user selecting biometric enrollment, (i) capture biometric data, (ii) encrypt the biometric data using the cryptographic key to create one or more of the five encrypted attributes, and (iii) store the biometric data on the user device.

17. A computer-implemented method for securely managing access to data and systems using encrypted attributes and real-time distributed network verification, the method comprising:
receiving, via a communication network, using a network interface of a system, and from an access management application executing on a user device associated with a user, a registration request to register the user in an access management system associated with the access management application;
creating, in response to the registration request, a cryptographic key, a proof protocol, a decentralized identifier, and a credential for the user;
transmitting, via the communication network, using the network interface, and to the access management application executing on the user device, the cryptographic key and the credential to cause the access management application to (i) prompt the user to select five different attributes for verification and (ii) encrypt the selected attributes using the cryptographic key to create five encrypted attributes;
receiving, via the communication network, using the network interface, and from the access management application executing on the user device, the five encrypted attributes;
registering the user on a distributed ledger of the access management system using the decentralized identifier and the five encrypted attributes;
receiving, via the communication network, using the network interface, and after registering the user, an authentication request comprising the proof protocol and the credential for the user;
determining, in response to receiving the authentication request, using the proof protocol, and via the distributed ledger of the access management system, whether a threshold number of current attributes corresponding to the five encrypted attributes match the five encrypted attributes; and
authenticating, in response to determining that the threshold number of current attributes corresponding to the five encrypted attributes match the five encrypted attributes, the authentication request.

18. The method of claim 17, comprising, when registering the user on the distributed ledger of the access management system, registering the user in the access management system by generating, on the distributed ledger, five tenants associated with the decentralized identifier, wherein each tenant of the five tenants corresponds to an encrypted attribute of the five encrypted attributes.

19. The method of claim 18, comprising, when determining whether the threshold number of current attributes corresponding to the five encrypted attributes match the five encrypted attributes:
simulating, in response to receiving the authentication request, using the five tenants associated with the decentralized identifier, and using the proof protocol, current attributes of the user to determine, for each tenant of the five tenants, whether a simulated current attribute of the simulated current attributes, matches the encrypted attribute corresponding to the tenant;
determining whether a first number of simulated current attributes that match the five encrypted attributes satisfies a first threshold;
determining, in response to determining that the first number of simulated current attributes that match the five encrypted attributes satisfies the first threshold, using the five tenants associated with the decentralized identifier, and using the proof protocol, actual current attributes of the user to determine, for each tenant of the five tenants, whether a determined actual current attribute of the determined actual current attributes, matches the encrypted attribute corresponding to the tenant;
determining whether a second number of determined actual current attributes that match the five encrypted attributes satisfies a second threshold; and
determining that the threshold number of current attributes corresponding to the five encrypted attributes matches the five encrypted attributes if the second number of determined actual current attributes that match the five encrypted attributes satisfies the second threshold.

20. The method of claim 17, comprising, after authenticating the authentication request:
receiving, using the access management system and from a device associated with the user, an access request to access data; and
permitting, in response to authenticating the authentication request and in response to receiving the access request, the device to access the data.
